(19) United States
(12) Patent Application Publication
(10) Pub. No.: US 2009/0195074 A1
(43) Pub. Date: Aug. 6, 2009

(54) Power supply and storage device for improving drilling rig operating efficiency

(76) Inventor: Edward R. Buiel, Poland, OH (US)

Correspondence Address: Robert C. Curfiss, 19826 Sundance Drive, Humble, TX, 77346-1402, US

(21) Appl. No.: 12/012,106

(22) Filed: Jan. 31, 2008

(51) Int. Cl. H02J 7/34

(52) U.S. Cl. 307/48

(57) ABSTRACT

An energy supply and storage system for a rig power supply system is disclosed for a rig power supply system of the type having a power generator coupled to rig loads and motors via a bus. The energy supply and storage device is a power supply in parallel with the rig motors and adapted for receiving energy generated by the generator in excess of demand. The energy storage system is in communication with the power supply for receiving and storing the excess energy, with the power supply being adapted to draw energy from the storage system when the rig motor demand exceeds the capacity of the generator.

### BACKGROUND OF THE INVENTION

1. Field of the Invention

The present invention is generally related to power systems for drilling rigs and is specifically directed to an apparatus and a method for improving the efficiency of the conversion of chemical energy to electrical energy and for improving the energy efficiency of the rig through regeneration and improved power factors.

2. Description of the Prior Art

In the petroleum exploration industry the equipment used to bore wells for oil and gas recovery is commonly known as a drilling rig. Over the years, various types of rigs have been used by the industry and have been classified either by reference to the type of power used on board the rig to provide the motive force necessary to turn the drill bit or perform the other rig operations or as to the type of terrain on which the rig is situated. For example, a rig may be termed an “offshore” rig if it is one used for offshore drilling, but more commonly rigs are referred to as mechanical, DC/DC “Ward-Leonard” or AC/DC (SCR type), or VFD drive rig (AC-DC-AC) for the most modern rigs depending upon the type of power coupling used to provide motive force for the drilling operations, specifically, the type of power coupling used to provide the hoisting, hydraulic and rotational force for the drilling bit.

Recent advances in drilling rig efficiency have focused on increasing the boring rate. Key technological advancements in better bit design, more powerful rigs, and increased hydraulic horsepower have resulted in requiring fewer days to drill holes of any given depth. This is particularly important under current conditions wherein the rig operating efficiency is measured in drilled feet per gallon of diesel fuel burned and the price of fuel is at an all time high. Hydraulic Horsepower is the horsepower dedicated to mud pumps which pump mud at high pressure down the drill string to the bit and then returns up the well bore to surface. The typical average hydraulic horsepower on a rig prior to 2001 was 300-425 horsepower. In 2007, the typical average hydraulic horsepower on drill rig increased to 650-1150 horsepower. This significant increase in hydraulic horsepower results in a significant increase in the overall rig fuel consumption rate. As such the need for conservation of energy utilized and improved power management will become critical to remain competitive in the market place.

Over the last few decades, SCR and VFD rigs have become much more common and DC/DC and mechanical rigs are becoming scarce. The SCR and VFD rigs use a pool of diesel engine driven AC generators, or gensets, to produce alternating current power to a rig bus, from which AC motors, or DC motors via an AC to DC power converter (Silicon Controlled Rectifier) are used to perform various rig operations, including by way of example, running mud pumps, driving the drilling bit and lifting the drill string.

Typical operation of the rig results in a highly dynamic power consumption profile that leads to inefficiency. Specifically, the rig power source has to be prepared to provide maximum power on demand and this means that during periods of low power consumption the rig power source is producing or has the capacity to produce more power than is required, making the operation inefficient. This is because the size of the gensets is sufficient to operate in a manner to produce full power during periods of high demand. In addition, the typical rig is configured to operate in a failsafe manner such that failure of a portion of the gensets will not shut down the rig. This is critical because anytime a rig operation is shut down it is possible that the well will be lost. At a minimum, hours to days of drilling time may be lost. Under current practices it is necessary to further oversize the gensets on SCR rigs in order to compensate for the poor/lagging power factor.

The typical genset configuration results in power factor inefficiencies which are roughly equal to the ratio of the actual output to the full voltage output capability. This results in higher fuel consumption by running the engine (typically a diesel engine) at a lower than optimum efficiency. In addition, many of the operational motors such as the mud pumps typically operate at high pressure (and high current) and speeds lower than rated. It is not uncommon to operate at power factors of 0.4 to 0.5 lagging. Also, during periods of transient loads, it is not possible for the generation of power from the gensets to match the dynamic load of the operational equipment and dramatic power factor inefficiencies occur during the period required by the gensets to compensate for the changing load. Finally, the potential energy of the lowering string is typically dissipated in an auxiliary electric brake, water brake, mechanical brake pads and/or a braking resistor.

In summary, in order to maintain full operational capability of the rig, the power capacity must greatly exceed the need during low consumption in order to assure full power on an as needed basis. In addition, the power capacity must be sufficient to continue operation of the rig in the event of partial failure of the power source. Without such contingencies any shut down of the rig can result in catastrophic consequences.

Generally speaking, the prior art has attempted to solve the problem presented during peak demand operations due to poor power factors in one of three ways:
1. The two motors driving mud pumps were connected in series to limit the current demand placed upon the power generation system. This solution was obviously not effective on single motor mud pumps, or when as commonly occurred, pumps had to be run at a greater than 50% speed to produce the required volume. Furthermore, even if pumps were placed in series, it was still necessary to provide additional engine-gensets to provide KVAR for the draw works during tripping operations or when making additional connections.
2. Banks of capacitors were installed on the rig bus to supply a fixed amount of leading KVAR. This attempted solution also had several disadvantages. At low loads, the corrected power factor could be as poor leading as a result of the added KVAR as it was lagging without the compensation by the capacitors. Because the available power factor compensation was voltage dependent, and an increased KVAR demand (low voltage) was not met by an increased capability to compensate the power factor, voltage regulation was adversely affected. Furthermore, system short circuit current was significantly increased, often beyond the original rig design limits, and the introduction of capacitance gave the system both sub-synchronous and super-synchronous resonant frequencies not easily calculated but within the range of excitation by the SCR drive system, thereby creating potential system stability problems.
3. The rig generators were oversized, such that it was not uncommon to find 1500 KVA generators on 850 KW engines. Even this solution was not often sufficient and was expensive when done for all engine-generator sets. Aside from the higher initial capital expense required to provide oversize generators, the operation of oversized lightly loaded generators was inherently inefficient.
4. A power factor controller was provided for AD/DC drilling rigs and utilized a controlled, unloaded, over-excited generator to provide reactive power to maintain the rig power factor within acceptable limits during peak demand operations, see for example, U.S. Pat. No. 4,590,416, entitled: “CLOSED LOOP POWER FACTOR CONTROL FOR POWER SUPPLY SYSTEMS,” issued to Michael N. Porche, et al, on May 20, 1986.

While each of these approaches worked toward assuring the availability of power during peak periods, each was deficient in that it either did not greatly reduce the inefficiency of the system or was inherently unstable. Both conditions are detrimental to the safe and efficient operation of the rig.

### SUMMARY OF THE INVENTION

The subject invention incorporates an electrical energy storage component in the rig power supply system which may be used to capture energy typically dissipated by an auxiliary electric brake, water brake, mechanical brake pads and/or a braking resistor, provide a means for actively controlling the power factor, and provide a means to perform peak shaving, i.e., to provide power during periods of high dynamic load. This allows the electrical generator units to be more correctly sized to the average power load rather than the peak power load. This also allows for much more efficient control of the generators while at the same time ensuring that sudden requirements for high power beyond the operating limits of the currently activated generators can be reliably met during unforeseeable periods of peak demand.

The system of the subject invention is adapted for providing instantaneous power to match the load requirements, for providing continuous power factor correction to ensure near-unity operation, for capturing energy typically dissipated by the an auxiliary electric brake, water brake, mechanical brake pads and/or a braking resistor and for allowing the engine-generators to be more accurately matched to the average load of the drilling rig while running continuously at a more efficient level of operation.

The crux of the invention is an active power factor correction and energy storage device that is directly connected to the AC bus. The device stores energy when surplus power is available from the gensets and regenerative braking system, rather than dissipating it by the braking resistor, and provides source power during periods of peak demand and power factor correction.

It is an important feature of the invention that the system provided herein permits the reduction of the number of operating gensets on the rig. In practice, rigs have different numbers of generators typically 2 to 6. In some cases, less than all generators are in simultaneous operation. In other cases all generators may be run. This may be needed in periods of peak demand when the battery is at a low state of charge. That is, the present invention may actually increase the demand on the generators rather than reduce it. Specifically, the configurations of the present invention permit the generators to run at a higher state of efficiency. This is because the need for over capacity is reduced or eliminated by the peak shaving function of the power conditioner and energy storage device. Excess power is stored in the energy storage device during periods of off-peak demand and then used during periods of peak demand. Generators can then be started and stopped over longer time intervals to provide the average power requirement of the rig and the state of charge of the energy storage device.

In the past, the additional capacity was needed and had to be continuously operating because of the lag time in bringing up an additional genset from a dormant or an off condition. The storage/source system of the subject invention provides additional power on demand, eliminating the need to have ready reserve generating capacity. This not only provides a consistent source of power on demand but eliminates the costs associated with supplying and supporting the additional genset and the associated increase in fuel required to operate the same. With this feature, the additional costs of incorporating the system of the subject invention in a rig power supply is greatly neutralized by the cost savings associated with the reduction in the number of operating gensets. By way of example, if two gensets are operating at 40% using prior art systems versus one genset operating at 80% using the configuration of the subject invention, the fuel usage is much higher because the generator efficiency decreases at lower loading. Typically, 80% load is near optimum efficiency.

Overall engine generators maintenance cost will be reduced by the use of invention. Typical engine generator service and maintenance costs are in the $2-4 per hour for each engine generator. This made up of oil consumption, oil and filter changes, AC generator overhaul, engine top jobs and major overhaul costs. Due to the engines generator system being run at higher average loads and in a more efficient manner the overall the result will be a significant reduction in the over all cost ownership of the rig engine generator package. In addition, the fact that much of the time you will be running one less engine generator than normal will provide even more significant savings.

It is also an important feature of the invention that the genset system can be configured to operate at or near maximum efficiency by selecting gensets that operate at highest efficiency during rig average load conditions. Since the rig power requirements are at both below average and above average much of the time, the prior systems required the gensets to have the capacity to operate at maximum requirements. The storage/source system of the subject permits the gensets to be configured to operate at or near maximum efficiency based on average load conditions. During periods of low loading the generated power is stored. During periods of high use, or sudden increase in demand, the stored power is withdrawn.

In its simplest form the storage/source system of the subject invention comprises a power supply and power conditioner which is placed in the position of the braking resistor in a genset power supply system. An energy storage device, such as a bank of lead acid batteries, or the like, is in communication with the power supply and power conditioner and receives and stores energy when excess power is generated during periods of below average requirements. The storage device then provides a source of power through the power supply and power conditioner whenever the power demands exceeds the average level. This system greatly enhances the efficiency of the rig power system.

A system controller is provided for automatically starting/stopping the generators based on load conditions and for determining when to pull power from the batteries and when to store energy in the batteries.

Other advantages and features of the invention will be readily apparent from the accompanying drawings and description.

### DESCRIPTION OF THE DRAWINGS

FIG. 1 (PRIOR ART) is a typical three genset rig power system with a DW braking resistor for slowing the drawworks DC motor(s) to cathead speed.

FIG. 2 is a first configuration of a rig power system in accordance with the subject invention for a rig with AC drives with a common DC bus.

FIG. 3 is an alternative configuration of a rig power system similar to that shown in FIG. 2 and in accordance with the subject invention for a rig with AC motors with a common DC bus.

FIG. 4 is an additional configuration of a rig power system in accordance with the subject invention for a rig with DC drives.

FIG. 5 is an alternative configuration of a rig power system in accordance with the subject invention for a rig with DC drives without a common DC bus.

FIG. 6 is a typical power consumption graph of a rig during operating mode.

FIG. 7 is a table comparing power generation and consumption of a prior art system with that of the subject invention.

FIG. 8 is a system controller configuration for a rig system having AC drives with a common DC bus, such as that shown in FIG. 2.

FIG. 9 is a system controller configuration for a rig system having AC drives without a common DC bus, such as that shown in FIG. 5.

FIG. 10 is a system controller configuration for a rig system having DC drives, such as that shown in FIG. 4.

### DESCRIPTION OF THE PREFERRED EMBODIMENT

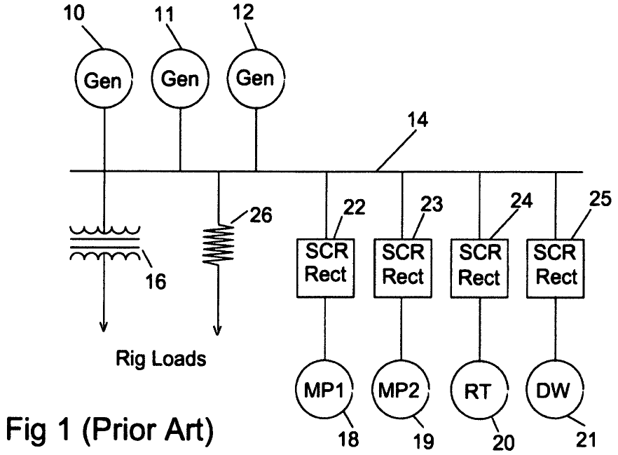

With reference to the PRIOR ART system of FIG. 1, the typical rig power supply circuit comprises two or more generators 10, 11 and 12 typically coupled by a bus 14 to various rig loads as indicated at 16 and rig motors such as indicated at 18, 19, 20 and 21. It should be understood that the number of generators is arbitrary depending upon rig configuration. In the embodiment shown the rig motors are connected to the bus through dedicated AC/DC converter circuits 22, 23, 24 and 25, respectively. However, it should be understood that the prior art systems may also include an AC/DC converter and chopper circuit arrangement between the various motors and the bus. A braking resistor 26 is also part of the circuit and is connected to the bus. In operation, the generators operate at a selected level and the various loads and motors draw power as needed. Excess power is dissipated through the braking resistor.

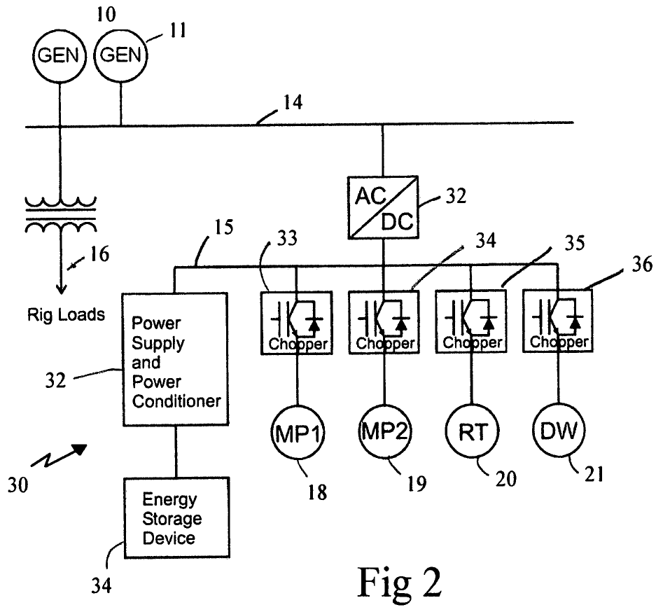

As shown in FIGS. 2-5, the storage/source system 30 of the subject invention comprises a power supply and power conditioner unit 32 and an energy storage device 37. A typical power supply and power conditioner unit 32 similar to a Siemens Sibac energy storage system and an Elspec Equalizer system with advanced power. A typical energy storage device is deep cycle lead acid batteries, available from Axion Power, Trojan, US Battery, and Exide, by way of example.

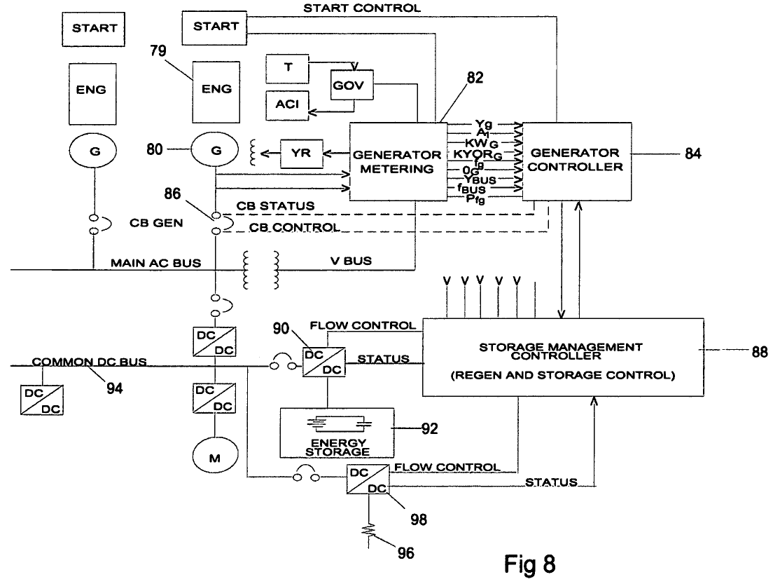

A controller system is an integral component of the power supply and power conditioner 32 and monitors load, energy storage, state of charge, and other information in order to determine how many generators to run, when to start/stop generators, and other typical functions. Block diagrams for various configurations of the controller system are shown in FIGS. 8-10, which are described herein.

In the configuration of FIG. 2, an AC/DC converter is between the primary bus 14 and a secondary bus 15 with the storage/source system 30 coupled directly to the secondary bus. In this configuration the rig loads 16 draw directly from the generators 10 and 11 and are not in communication with the storage/source system 30. The storage/source system 30 is in communication with the various rig motors 18, 19, 20 and 21 via the secondary bus 15 and the DC/AC converter circuits 33, 34, 35, and 36. In operation, when the generators 10 and 11 are generating more energy than demanded by the motors the excess energy is drawn by the power supply and power conditioner 32 and stored in the energy storage device 37. When the motors demand more power than being generated by the generators 10 and 11 stored energy is withdrawn from the energy storage device via the power supply and power conditioner 32 via secondary bust 15.

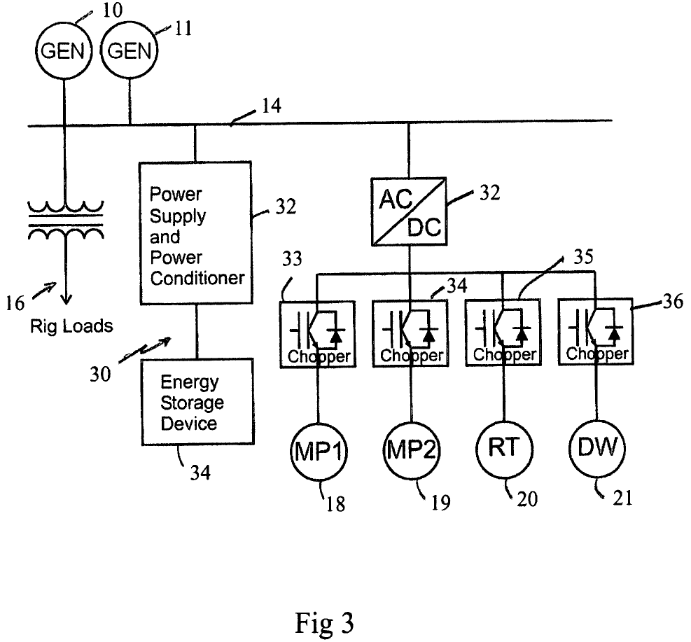

In the configuration of FIG. 3 the storage/source system 30 is connected in parallel with rig loads 16 and the AC/DC converter 32 and is coupled directly to the primary bus 14. This permits the rig loads 16 to also draw energy from the energy storage device 37.

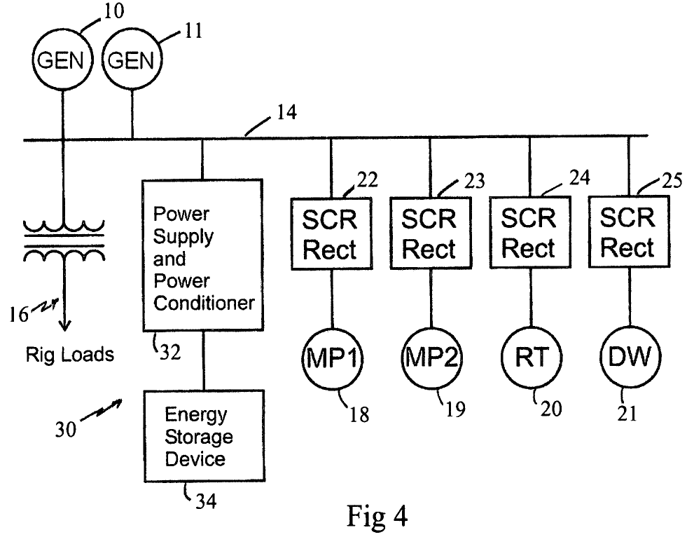

The configuration of FIG. 4 is similar to that of FIG. 3 except that the AC/DC converter is not required and the AC/DC converter circuits 22, 23, 24 and 25 in one-to-one relationship with the rig motors 18, 19, 20 and 21.

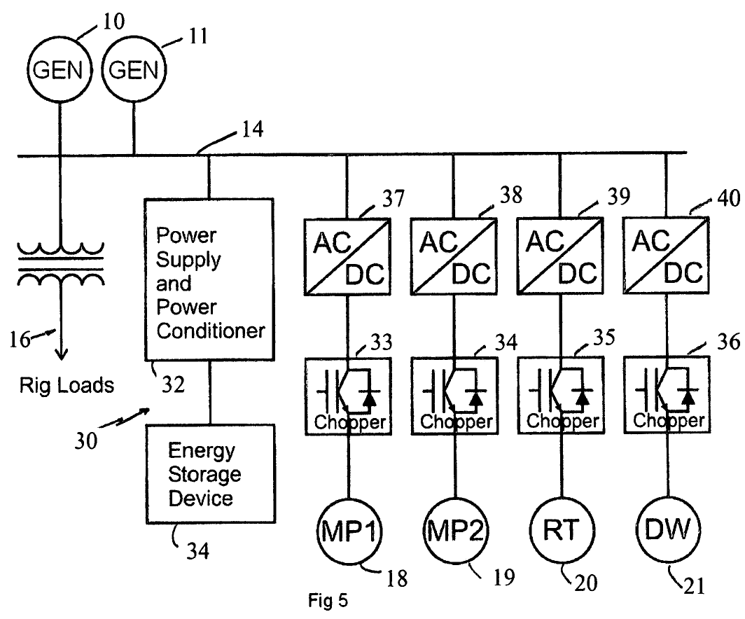

The configuration of FIG. 5 is similar to that of FIG. 4 with dedicated AC/DC converters 37, 38, 39 and 40 and dedicated DC/AC converter circuits 33, 34, 35 and 36 in one-to-one relationship with rig motors 18, 19, 20 and 21.

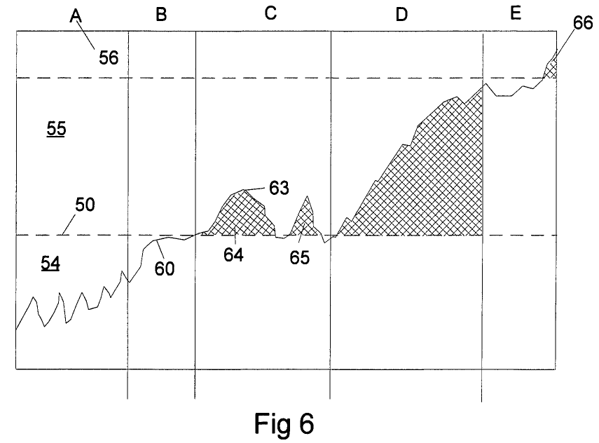

The graph of FIG. 6 is illustrative of typical operational modes utilizing a two generator system coupled with the storage/source system of the subject invention. As there shown, the maximum efficiency run speed of generator 10 is represented by the dotted line 50. During the cycle indicated by block A the load requirements are less than 50% of the capacity of generator 10, as indicated by line segment 52. During this period the excess power generated by generator 10, indicated by the area 54 above line 52 and below line 50, is stored in the energy storage device of the subject invention. All of the power generated by the second generator 11, represented by the area 55 between line 50 and 56 is stored in the energy storage device of the subject invention.

The energy demand remains within the capacity of the first generator 10 in block B, as indicated by the line segment 60. As indicated in block C, when the energy demand exceeds the capacity of generator 10, energy is supplied by generator 11, see line segment 62 and the areas under this line segment indicated by 64 and 65. During this mode of operation, all of the capacity of generator 10 is being used by the rig loads and motors, with the excess capacity of generator 11 being stored in the energy storage device of the subject invention. As indicated by block D, this continues during any operational mode where the capacity of generator 10 is exceeded but the power requirements are less than the combined capacity of generators 10 and 11.

During peak demand periods as indicated in block E, when the demand exceeds the combined capacity of both generators 10 and 11, as indicated at area 66, the excess energy demands are met by withdrawing stored energy from the energy storage device of the subject invention.

Various configurations of the controller system are shown in FIGS. 8, 9 and 10. Certain symbols are common to each of the drawings, as follows:
AC/DC Alternating Current to Direct Current Conversion
Act Actuator
A_{g} Amps—Generator
b Bus
CB Circuit Breaker
CB_{g} Circuit Breaker—Generator
CT Current Transformer
DC/DC Direct Current to Direct Current Conversion
DW Drawworks
Eng Engine—Prime Mover
f_{b} Frequency—Bus
f_{g} Frequency—Generator
pf_{b} Power Factor—Bus
pf_{g} Power Factor—Generator
g Generator
G Generator
Gov Governor
KVAR_{g} KiloVars—Generator
KW_{g} KiloWatts—Generator
M Motor
Ø_{g} Phase—Generator
PT Potential Transformer
Start Starting Unit for Prime Mover
T Tachometer
V_{b} Voltage—Bus
V_{g} Voltage—Generator
VR Voltage Regulator

With specific reference to FIG. 8, the controller system there shown is adapted for a rig system having AC drives with a common DC bus, similar to that sown in FIG. 2. The following signals are generated for each engine (Eng) 79 and generator (G) 80 set: Volts (Vg), Amps (Ag), Kilowatts (KW), KiloVars (Kvar), Power Factor (pf_{g}), Frequency Generator (f_{g}), Volts Bus (V_{b}), Frequency Bus (f_{b}) and Phase Reference (Ø_{g}) (Ø_{b}) for synchronizing the generators (G). This permits comprehensive metering of the generator, as indicated at generator metering block 82.

The generator controller 84 receives inputs from the generator metering block 82, from the circuit breaker (CB_{g}) 86 and from the energy management controller 88. The generator controller 84 is responsible for auto starting and auto stopping of engines, for synchronizing generators and for auto closure/opening of the generator circuit breaker (CB_{g}) 86.

The energy storage converter 90 consists of a bidirectional DC to DC converter. Based upon commands from the energy management controller 88 it will charge the energy storage devices 92 or it will provide energy back to the main DC bus 94. The converter 90 also monitors the amount of energy currently stored and the overall health of the storage devices 92. If storage capacity exists, the management controller 88 will throttle back on the energy dissipated in a resistor bank 96 via the dynamic braking chopper 98 and will convert it to stored energy in the energy storage devices 92. The energy storage device(s) may consist of, but is not limited to, a system of batteries, capacitors, ultracapacitors, flywheels, or combinations thereof. The dynamic chopper 98 typically exists on AC style drawworks for dissipation of energy into the resistor bank 96. The drawworks resistor bank 96 is utilized to convert mechanical energy from the drawworks motor 100 into heat energy.

The energy management controller 88 is responsible for controlling how much energy will be stored and when engines need to be switched on or off. This controller receives the generator metering information from each generator metering block 82, circuit breaker 86 and engine status from the generator controller 84. It also receives energy storage status from the energy storage converter 90, regenerative energy status from the energy storage converter 90 and the DW dynamic braking chopper 98. Based on rig drilling requirements this controller will provide outputs to the energy storage converter 90 to store excess generated energy. Once the stores are charged, if rig demand allow, generators will automatically be switched off to conserve fuel usage. Once the energy stores are utilized and/or rig demands require additional capacity this controller 88 will signal the generator controller 84 to bring online additional capacity.

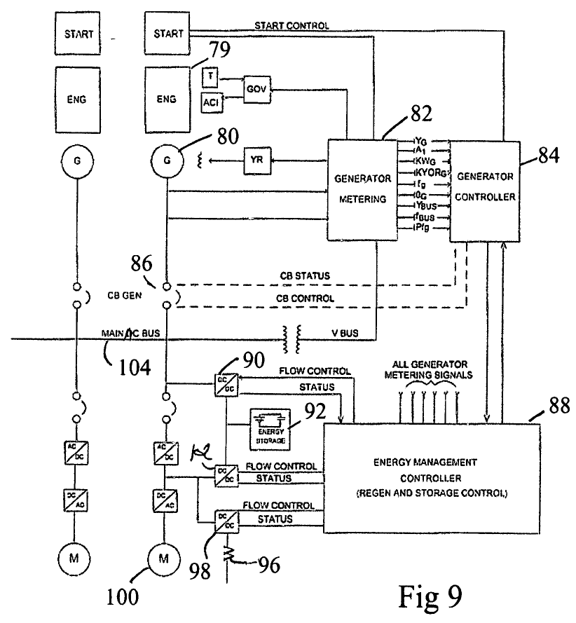

FIG. 9 shows a controller system for a rig having AC drives without a common DC bus. Like components have the same reference numeral and basically the same function as those components in FIG. 8. The drawworks regeneration converter 102 is used to store the energy from the drawworks 100. If storage capacity exists the energy management controller 88 will throttle back on the energy dissipated in a resistor bank 96 via the dynamic braking chopper 98 and will convert it to stored energy in the energy storage devices 92.

The energy storage converter 90 consists of a bidirectional DC to DC converter. Based on commands from the energy management controller 88 the energy storage converter 90 will charge the energy storage devices 92 or it will provide energy back to the main AC bus 104. The energy storage converter 90 also monitors the amount of energy currently stored and the overall health of the storage devices 92.

The DW generation converter 102 is used to store energy from the drawworks 100. If storage capacity exists the energy management controller 88 will throttle back on the energy dissipated in the resistor bank 96 via the dynamic chopper 98 and will convert it to stored energy in the energy storage devices 92.

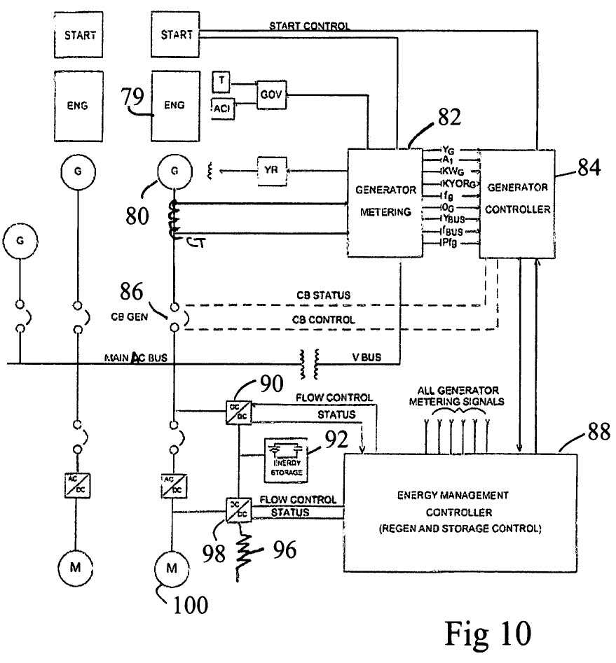

FIG. 10 shows a controller system for a rig having DC drives. Like components have the same reference numeral and basically the same function as those components in FIGS. 8 and 9. In this configuration the energy storage converter consists of the bidirectional DC to DC converter 90. Based on commands from the energy management controller 88 it will charge the energy storage devices 92 or it will provide energy back to the AC main bus 104. The converter 90 also monitors the amount of energy currently stored and the overall health of the storage devices 92. The DW regeneration storage converter 102 is used to store the energy from the drawworks 100. If storage capacity exists the energy management controller 88 will convert the DW energy and store it in the energy storage devices 92. In this configuration a power factor corrector generator or the converter 90 provides power factor correction to the main bus 104 based upon signals that they receives from the energy management controller 88.

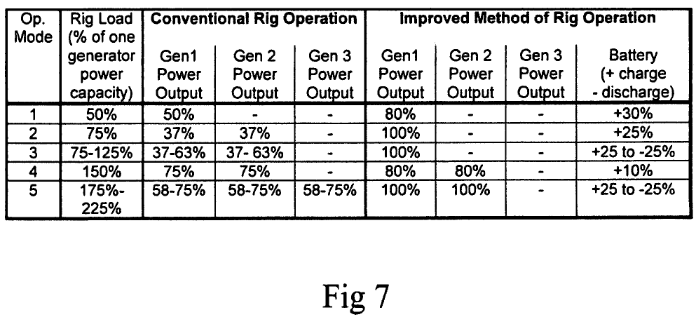

The subject invention greatly enhances the efficiency of the entire system by permitting selective use of the available generators on an as necessary basis and by permitting operating generators to run at close to maximum efficiency by storing rather than dissipating excess energy and by utilizing stored energy during peak demand, as indicated by the table of FIG. 7. This system permits each generator to operate at high efficiency as well as preserving excess energy generated during operation.

While certain features and embodiments of the invention have been described in detail herein, it should be understood that the invention encompasses all modifications and enhancements within the scope and spirit of the accompanying claims.

What is claimed is:

1. An energy supply and storage system for use in combination with a rig power supply system, the rig power supply system of the type comprising a power generator coupled to rig loads and motors via a bus, an automated control system for power generation and overall rig power control, the energy supply and storage device comprising:
a. a power supply in parallel with the rig motors and adapted for receiving energy generated by the generator in excess of demand;
b. an energy storage system in communication with the power supply for receiving and storing the excess energy, the power supply being adapted to draw energy from the storage system when the rig motor demand exceeds the capacity of the generator; and
c. an automated control system for rig power management including generator start/stop and power output control.

2. The energy supply and storage system of claim 1, wherein the power supply is also adapted for conditioning the power on the bus.

3. The energy supply and storage system of claim 1, wherein the power supply is also adapted for conditioning the energy stored in and withdrawn from the energy storage system.

4. The energy supply and storage system of claim 1, wherein the energy storage system comprises lead acid batteries.

5. The energy supply and storage system of claim 1, wherein the energy storage device comprises ultra-capacitors.

6. The energy supply and storage system of claim 1, wherein the energy storage device comprises hybrid battery/super-capacitors.

7. The energy supply and storage system of claim 1, wherein the energy storage device comprises Nickel Metal Hydride batteries.

8. The energy supply and storage system of claim 1, wherein the energy storage device comprises Lithium Ion batteries.

9. The energy supply and storage system of claim 1, wherein the energy storage device comprises flow batteries.

10. The energy supply and storage system of claim 1, wherein the energy storage device comprises a system for reversibly storing electrical energy.

11. The energy supply and storage system of claim 1, wherein the energy storage device comprises fly wheels.

12. The energy supply and storage system of claim 1, wherein the rig loads are also in parallel with the power supply and storage system.

13. The energy supply and storage system of claim 1 further including a braking resistor.

14. In a drilling rig wherein an engine-generator set forms an alternating current (AC) power supply system for operating the rig electrical equipment and machinery an improvement comprising:
a. a bi-directional AC/DC converter for converting the AC power generated by the engine-generator set; and
b. an electrical storage device by which the excess energy not utilized by the rig can be stored.

15. The drilling rig of claim 13, wherein the energy storage device comprises batteries.

16. The drilling rig of claim 13, wherein the batteries are lead acid batteries.
